(19) United States
(12) Patent Application Publication
(10) Pub. No.: US 2014/0263702 A1
(43) Pub. Date: Sep. 18, 2014

(54) Spraying Apparatus And Spraying Method Of Water And Air Having Effected 4D

(71) Applicant: CJ 4D PLEX CO., LTD., Seoul (KR)

(72) Inventors: Jae Sung Choi, Daejeon (KR); Jong Su Choi, Daejeon (KR)

(21) Appl. No.: 14/353,368

(22) PCT Filed: Dec. 7, 2012
(86) PCT No.: PCT/KR2012/010587

§ 371 Date: Apr. 22, 2014

(30) Foreign Application Priority Data
Feb. 1, 2012 (KR) 10-2012-0010492

(51) Int. Cl. B05B 7/02

(52) U.S. Cl. CPC B05B 7/02
USPC 239/8; 239/413

(57) ABSTRACT

The present invention relates to a spraying apparatus and a spraying method of water and air having effected 4D, and more particularly, to a spraying apparatus and a spraying method of water and air having effected 4D capable of controlling power of sprayed water and air and spraying water and air from one nozzle.

### TECHNICAL FIELD

The present invention relates to a spraying apparatus and a spraying method of water and air having effected 4D, and more particularly, to a spraying apparatus and a spraying method of water and air having effected 4D capable of controlling power of sprayed water and air and spraying water and air from one nozzle.

### BACKGROUND ART

In the past, facilities for showing pictures like a theater simply show only pictures to spectators, but in recent years, present various effects to spectators while showing pictures. That is, a general theater in the past is a place at which spectators merely watch audiovisually pictures, while a recent theater has been developed to a place at which spectators visually show pictures and directly experience various effects with their bodies.

Generally, a theater at which spectators can show specially photographed pictures and can visually feels a three-dimensional effect of pictures is generally referred to as a ‘3D theater’, while a theater at which spectators watch pictures with five senses by stimulating a sense of touch, a sense of smell, and the like, in addition to visual and auditory senses is referred to as a ‘4D theater’.

The first 4D theater may be said to be Ripley's Moving theater that was opened in USA in 1989. The Ripley's Moving theater is implemented so that spectators may directly experience rain, air, snow, and the like, as a special effect meeting contents of pictures while specially produced pictures of 20 minutes are shown.

Generally, an apparatus of spraying water or air to spectators in the 4D theater according to the related art is configured to include at least two nozzles, such that water and air are each sprayed from a separate nozzle. In this case, a configuration of the spraying apparatus is complicated, such that manufacturing costs of the spraying apparatus are increased and it is difficult to manage the spraying apparatus.

In the 4D theater, in the case of air, there is little problem even after air is sprayed to spectators, but in the case of water, when a large amount of water is sprayed, clothes of spectators are wet or spectators can feel unpleasant feeling and as a result, there is a need to spray a proper amount of water to spectators However, the spraying apparatus according to the related art essentially includes a relatively expensive water solenoid valve, such that manufacturing costs of the spraying apparatus may be relatively expensive and a sprayed amount of water may not be accurately controlled.

### DISCLOSURE OF INVENTION

Technical Problem

The present invention has been made in an effort to provide a spraying apparatus and a spraying method of water and air having effected 4D capable of regulating power of water and air sprayed from a discharge port of a nozzle according to mutual opened/closed states of three solenoid valves and spraying water and air from one nozzle.

Solution to Problem

In one general aspect, a spraying apparatus of water and air having effected 4D, includes: a nozzle including one spraying port and first, second, and third inlets; a main air line having one end connected with the first inlet of the nozzle; a first air line having one end branched from the other end of the main air line, including a first regulator and a first solenoid valve, and having the other end connected with an air supply source; a second air line having one end branched from the other end of the main air line, including a second regulator 221 and a second solenoid valve, and having the other end connected with the air supply source; a water line having one end connected with a second inlet of the nozzle and the other end connected with a water supply source; and a third air line having one end connected with the third inlet of the nozzle, including a third regulator and a third solenoid valve, and the having other end connected with the air supply source, wherein when the air is sprayed, the first solenoid valve or the second solenoid valve is maintained in an opened state and the third solenoid valve is maintained in a closed state, and when the water is sprayed, the third solenoid valve and the first solenoid valve or the third solenoid valve and the second solenoid valve are maintained in the simultaneously opened state.

The first, second, and third solenoid valves may be consisted of a pneumatic solenoid valve.

The water line 300 may further include a flow control valve that controls a flow rate.

In another general aspect, a spraying method of water and air having effected 4D, includes: determining, by a main controller, whether water or air is to be sprayed; determining spraying strength of the water or air when it is determined that the water or the air is to be sprayed; determining whether the first solenoid valve, the second solenoid valve, and the third solenoid valve are opened or closed with respect to one another according to a determination signal of the spraying strength; and spraying water or air from the spraying port of the nozzle according to the determination of whether the first, second, and third solenoid valves are opened or closed with respect to one another.

In the determining of whether the first, second, and third solenoid valves are opened or closed with respect to one another, when the strong air is sprayed, only the first solenoid valve may be opened and the second solenoid valve and the third solenoid valve may be closed, when the weak air is sprayed, only the second solenoid valve may be opened and the first solenoid valve and the third solenoid valve may be closed, when the strong water is sprayed, the first solenoid valve and the third solenoid valve may be opened and the second solenoid valve may be closed, and when the weak water is sprayed, the second solenoid valve and the third solenoid valve may be opened and the first solenoid valve may be closed.

Advantageous Effects of Invention

According to the exemplary embodiment of the present invention, it is possible to spray water and air from an integrated nozzle, that is, one nozzle to simplify and miniaturize the configuration of the spraying apparatus, thereby saving the manufacturing costs and the maintenance costs of the spraying apparatus.

Further, according to the exemplary embodiment of the present invention, it is possible to use the pneumatic solenoid valve, thereby saving the manufacturing costs and accurately regulating the amount and strength of water sprayed through the pneumatic solenoid valve and the hydraulic control valve.

### BRIEF DESCRIPTION OF DRAWINGS

FIG. 1 is a configuration diagram of a spraying apparatus of water and air having effected 4D according to an exemplary embodiment of the present invention.

FIG. 2 is a flow chart of a spraying method of water and air having effected 4D according to an exemplary embodiment of the present invention.

### DESCRIPTION OF MAIN REFERENCE NUMERALS OF DRAWINGS

1: Spraying apparatus 100: Nozzle

110: Spraying port 111: First inlet

112: Second inlet 113: Third inlet

200: Main air line 210: First air line

211: First regulator 212: First solenoid valve

220: Second air line 221: Second regulator

222: Second solenoid valve 230: Third air line

231: Third regulator 232: Third solenoid valve

250: Air supply source 300: Water line

310: Flow control valve 350: Water supply source

400: Main controller

### BEST MODE FOR CARRYING OUT THE INVENTION

Hereinafter, exemplary embodiments of the present invention will be described in detail with reference to the accompanying drawings. In adding reference numerals to components of each drawing, like components are denoted by like reference numerals.

FIG. 1 is a configuration diagram of a spraying apparatus 1 of water and air having effected 4D according to an exemplary embodiment of the present invention. The spraying apparatus 1 of water and air having effected 4D according to an exemplary embodiment of the present invention is configured to include a nozzle 100, a main air line 200, a first air line 210 and a second air line 220 branched from the main air line 200, a water line 300, and a third air line 230.

A configuration of the spraying apparatus 1 of water and air having effected 4D according to an exemplary embodiment of the present invention will be described below with reference to FIG. 1.

The nozzle 100 includes one spraying port 110 and three inlets 111, 112, and 113. Preferably, the spraying port 110 may be located at a front surface of the nozzle 100 and the first, second, and third inlets 111, 112, and 113 may be formed at side and back surfaces of the nozzle 100 or side and bottom surfaces of the nozzle 100.

One end of the main air line 200 is connected with a first inlet 111 of the nozzle 100 and the other end of the main air line 200 is branched into the first air line 210 and the second air line 220.

One end of the first air line 210 is branched from the other end of the main air line 200 and the other end of the first air line 210 is connected with an air supply source 250. A first regulator 211 and a first solenoid valve 212 are mounted at a part of the first air line 210.

Similar to the first air line 210, one end of the second air line 220 is branched from the other end of the main air line 200 and the other end of the second air line 220 is connected with the air supply source 250. A second regulator 221 and a second solenoid valve 222 are mounted at a part of the second air line 220.

One end of a water line 300 is connected with the second inlet 112 of the nozzle 100 and the other end of the water line 300 is connected with a water supply source 350. In the exemplary embodiment of the present invention, the water supply source 350 may be a public water supply plant. In another exemplary embodiment of the present invention, a flow control valve 310 that can control a flow rate is mounted at a part of the water line 300. Preferably, the flow control valve 310 is mounted at the second inlet 112 of the nozzle with which one end of the water line 300 is coupled.

One end of a third air line 230 is connected with the third inlet 113 of the nozzle 100 and the other end of the third air line 230 is connected with an air supply source 250. Further, a third regulator 231 and a third solenoid valve 232 are mounted at a part of the third air line 230.

In the exemplary embodiment of the present invention, the air supply source 250 may be an air tank in which air supplied from a compressor is stored.

Further, in another exemplary embodiment of the present invention, first, second and third solenoid valves 212, 222, and 232 may be consisted of a pneumatic solenoid valve. Therefore, manufacturing costs may be saved by not using the relatively more expensive water solenoid than the pneumatic solenoid valve.

Although not illustrated in the drawings, a plurality of filters may be mounted on the main air line 200, the first, second, and third air lines 210, 220, and 230, and/or the water line 300. Air and water that are purified by passing through the filters are sprayed to spectators.

At the time of spraying air, the first solenoid valve 212 or the second solenoid valve 222 is opened according to strength of air to be sprayed in the state in which the third solenoid valve 232 is closed. That is, when strong air is sprayed, the strong air is sprayed to the spraying port 110 of the nozzle 100 in the state in which the third solenoid valve 232 and the second solenoid valve 222 are closed and only the first solenoid valve 212 is opened. That is, when weak air is sprayed, the weak air is sprayed to the spraying port 110 of the nozzle 100 in the state in which the third solenoid valve 232 and the first solenoid valve 212 are closed and only the second solenoid valve 222 is opened. Although not necessarily limited thereto, in the exemplary embodiment of the present invention, the strong air is sprayed at a pressure of about 7 bar and the weak air is sprayed at a pressure of about 3 bar.

When water is sprayed, the third solenoid valve 232 and the first solenoid valve 212 or the third solenoid valve 232 and the second solenoid valve 222 are simultaneously opened. That is, when strong water is sprayed, the strong water is sprayed to the spraying port 110 of the nozzle 100 by a pneumatic pressure in the state in which the third solenoid valve 232 and the first solenoid valve 212 are simultaneously opened and only the second solenoid valve 222 is closed. That is, when weak water is sprayed, the weak water is sprayed to the spraying port 110 of the nozzle 100 by a pneumatic pressure in the state in which the third solenoid valve 232 and the second solenoid valve 222 are simultaneously opened and the first solenoid valve 212 is closed. Although not necessarily limited thereto, the spraying apparatus 1 of water and air having effected 4D according to the present invention may be located at back surfaces of chairs on which spectators are seated.

Therefore, the exemplary embodiment of the present invention may spray the strong air, the weak air, the strong water, and the weak water from one nozzle 100 according to the state in which three solenoids are opened and closed with respect to one another, such that the number of used nozzles 100 is minimized and the manufacturing costs and the manufacturing time can be saved. Further, equipment is miniaturized and installation convenience is provided.

FIG. 2 is a flow chart of a spraying method of water and air having effected 4D according to an exemplary embodiment of the present invention. Hereinafter, in the exemplary embodiment of the present invention, the spraying method of water and air for effected 4D will be described with reference to FIG. 2.

A main controller 400 that codes the shown movie contents and transfers an actuation signal to each device according to the codes determines whether water or air is sprayed (S1). When the main controller 400 determines that water or air is to be sprayed, the main controller determines the spraying strength of water or air that is sprayed again (S2). It is determined whether the first solenoid valve 212, the second solenoid valve 222, and the third solenoid valve 232 are opened or closed with respect to one another according to the determination signal of the spraying strength of sprayed water or air (S3). The water or air is sprayed from the spraying port 110 of the nozzle according to the determination (S3) whether the first, second, and third solenoid valves 212, 222, and 232 are opened or closed with respect to one another (S4).

That is, in the determining whether the first, second, and third solenoid valves are opened or closed with respect to one another (S3), when the strong air is sprayed, only the first solenoid valve 212 is opened and the second solenoid valve 222 and the third solenoid valve 232 are closed. As the first solenoid valve 212 is opened, air discharged from the air supply source 250 flows along the first air line 210 and the air passes through the main air line 200 via the first regulator 211 at a pressure of about 7 bar and then, is sprayed to the spraying port 110 of the nozzle 100. When the weak air is sprayed, only the second solenoid valve 222 is opened and the first solenoid valve 212 and the third solenoid valve 232 are closed. Similar to the case in which the strong air is sprayed, as the second solenoid valve 222 is opened, the air discharged from the air supply source 250 flows along the second air line 220 and the air passes through the main air line 200 via the second regulator 221 at a pressure of about 3 bar and then, is sprayed to the spraying port 110 of the nozzle 100.

When the strong water is sprayed, the first solenoid valve 212 and the third solenoid valve 232 are opened and the second solenoid valve 222 is closed. The water supplied from the water supply source 350 passes through the water line 300 and then, is sprayed from the spraying port 110 of the nozzle 100 in the strong water state by the strong pneumatic pressure supplied from the third air line 230. When the weak water is sprayed, the second solenoid valve 212 and the third solenoid valve 232 are opened and the first solenoid valve 212 is closed. Similar to the case in which the strong water is sprayed, the water supplied from the water supply source 350 passes through the water line 300 and then, is sprayed from the spraying port 110 of the nozzle 100 in the weak water state by the weak pneumatic pressure supplied from the third air line 230.

The present invention is not limited to the modified examples shown in the drawings and the foregoing exemplary embodiments and therefore, may be extended to other exemplary embodiments belonging to the scope of the appended claims.

### INDUSTRIAL APPLICABILITY

The present invention relates to a spraying apparatus and a spraying method of water and air having effected 4D, and more particularly, to a spraying apparatus and a spraying method of water and air having effected 4D capable of controlling power of sprayed water and air and spraying water and air from one nozzle.

1. A spraying apparatus of water and air having effected 4D, comprising:
a nozzle including one spraying port and first, second, and third inlets;
a main air line having one end connected with the first inlet of the nozzle;
a first air line having one end branched from the other end of the main air line, including a first regulator and a first solenoid valve, and having the other end connected with an air supply source;
a second air line having one end branched from the other end of the main air line, including a second regulator and a second solenoid valve, and having the other end connected with the air supply source;
a water line having one end connected with a second inlet of the nozzle and the other end connected with a water supply source; and
a third air line having one end connected with the third inlet of the nozzle, including a third regulator and a third solenoid valve, and having the other end connected with the air supply source;
wherein when the air is sprayed, the first solenoid valve or the second solenoid valve is maintained in an opened state and the third solenoid valve is maintained in a closed state, and
when the water is sprayed, the third solenoid valve and the first solenoid valve or the third solenoid valve and the second solenoid valve are maintained in the simultaneously opened state.

2. The spraying apparatus of claim 1, wherein the first, second, and third solenoid valves are consisted of a pneumatic solenoid valve.

3. The spraying apparatus of claim 2, wherein the water line further includes a flow control valve that controls a flow rate.

4. A spraying method of water and air having effected 4D, comprising:
determining, by a main controller, whether water or air is sprayed;
determining spraying strength of the water or air when it is determined that the water or the air is to be sprayed;
determining whether the first solenoid valve, the second solenoid valve, and the third solenoid valve are opened or closed with respect to one another according to a determination signal of the spraying strength; and
spraying water or air from the spraying port of the nozzle according to the determination of whether the first, second, and third solenoid valves are opened or closed with respect to one another.

5. The spraying method of claim 4, wherein in the determining of whether the first, second, and third solenoid valves are opened or closed with respect to one another,
when the strong air is sprayed, only the first solenoid valve is opened and the second solenoid valve and the third solenoid valve are closed,
when the weak air is sprayed, only the second solenoid valve is opened and the first solenoid valve and the third solenoid valve are closed,
when the strong water is sprayed, the first solenoid valve and the third solenoid valve are opened and the second solenoid valve is closed, and
when the weak water is sprayed, the second solenoid valve and the third solenoid valve are opened and the first solenoid valve is closed.
